(19) United States
(12) Patent Application Publication
(10) Pub. No.: US 2004/0169839 A1
(43) Pub. Date: Sep. 2, 2004

(54) Device for observing the sun's backscattered image on a screen

(76) Inventor: Jean Gay, Nice (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/480,481

(22) PCT Filed: Dec. 24, 2002
(86) PCT No.: PCT/FR02/04557

(30) Foreign Application Priority Data
Jul. 16, 2002 (FR) 02/08984

(51) Int. Cl. G01C 3/00; G01C 3/08; G01C 5/00

(52) U.S. Cl. 356/3.11

(57) ABSTRACT

A device for the observation of passages on the sun of Venus and Mercury and more generally for observation of the solar disk by back projection of the solar image on a screen that also forms a sun screen for the protection of the eyes.

The present invention pertains to an optical device which has as object the presentation on a diffusing screen of an image of the sun of dimensions sufficient to allow observation by multiple people at the same time with a fineness of details enabling perception of sunspots but above all the passage of the planet Mercury in May 2003 and moreover the passage of the planet Venus in June 2004, phenomena which recur only every 122 years and the media coverage of which will be very intense. The method for the focusing of the image must remain accessible for all heights of the sun above the horizon taking into account that for most countries involved and taking into account the duration of the phenomenon (5 to 6 hours), the sun will remain very high on the horizon.

The passage of Venus over the solar disk will cause the public to observe the sun with all the risks of opthalmia that direct—even protected—observation of the sun can cause. A method that can guarantee both perfect visualization of the phenomenon as well as complete harmlessness should be provided to the public.

The passage of Venus in front of the sun is a rare event that only occurs in pairs of years separated by eight years every 122 years. The phenomenon is readily visible using a small instrument, but the risk of deterioration of the retina during direct observation requires use of a specific instrument that provides protection of the eye, and which can be widely distributed because of a modest price and ease of use.

The next passage of Venus will take place on Tuesday, Jun. 8, 2004, and will be visible in Asia, Europe and Africa, and to a marginal degree on the east coast of North America. The second occurrence in 2012 will be visible from America and the east of Asia but only the end will be visible from Europe.

The phenomenon lasts for approximately six hours. The planet will appear as a black disk, 58″ in diameter (i.e., approximately a thirtieth of the diameter of the sun) which will move along a chord of the solar disk.

The measurement of the transit time at different points of the globe in the 18^{th} century provided an initial measurement of the dimensions of the solar system. A pairing of different observers or schools from different countries and exchanges on the Internet of measurements performed, will provide everyone with access to a measurement of the dimensions of the solar system and thereby revive the great moments of international consensus of modern astronomy in its first manifestations.

But such an instrument will have many other applications. A general rehearsal will take place on May 7, 2003, upon the occasion of the passage of Mercury in front of the sun, a phenomenon which takes place more frequently and is less spectacular. The partial eclipses of Apr. 31, 2003, of Oct. 3, 2005 and of Mar. 29, 2006 will justify the use of this device. In addition to such events, the frequent observation of sunspots will certainly be a source of success. Other more esoteric observations can also be suggested: statistical counting of migratory birds, observation of the green flash, image of the solar protuberances in alpha ray if one adds to the system a pair of telescopic spectacles suitable for this radiation.

The telescopic spectacles and telescopes used by amateurs are often equipped with a system for projecting an image of the sun on a screen. But the telescopic spectacles and telescopes are often bulky and difficult to use. Moreover the general public lacks the experience required for direct observation of the solar disk since these devices do not provide any protection or means for preventing such a use. Binoculars, with which the public is more familiar, present a certain danger even when equipped with attenuator filters because they deliver a direct image on the retina of the observer. A projection system close to that which is proposed herein has been proposed but the adjustment system associated with it is not accessible for all viewing positions because, placed on the secondary mirror, it is engaged in the support base when the sun is at more than 45° of height.

The invention presented herein resolves the safety problem mentioned above and, moreover, makes possible adjustment for all viewing positions: the simplicity of the optical system ensures a production cost which is an order of magnitude lower than that of small amateur telescope. The combination of the elements makes it impossible to expose the eye at any point to direct solar radiation, thereby ensuring essential protection of the retina of the observer.

Better understanding of the invention will be obtained from the description below of a nonlimitative example of implementation with reference to the attached drawings in which:

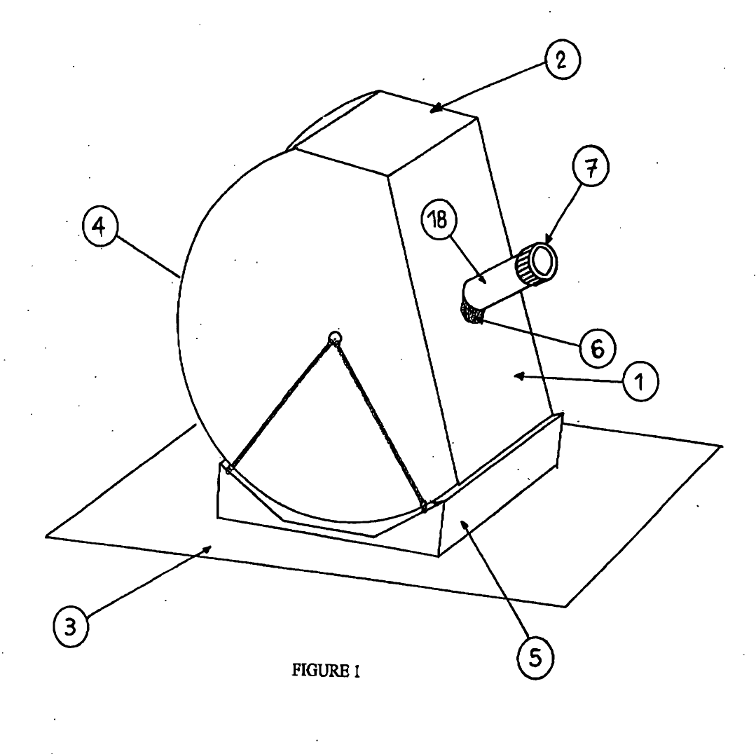

FIG. 1 represents the external appearance of the system viewed from the side illuminated by the sun;

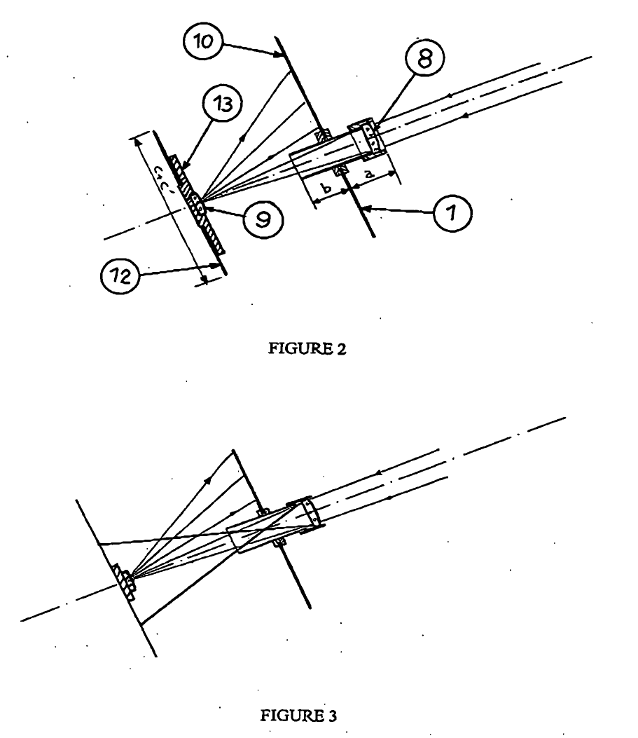

FIG. 2 depicts the optical combination;

FIG. 3 illustrates the protection of the eye from the direct solar image;

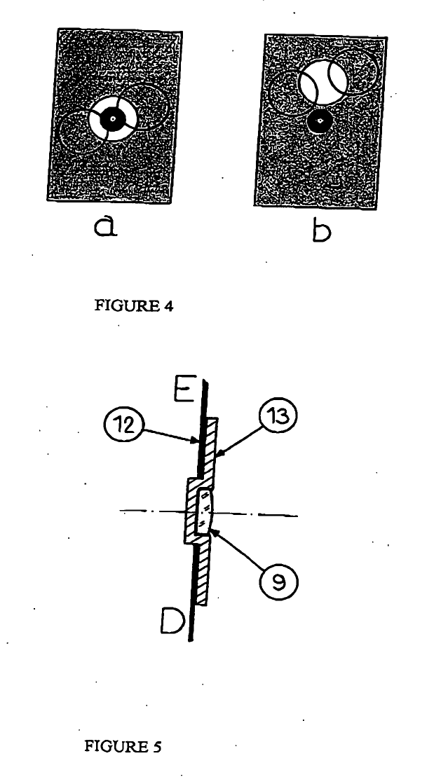

FIG. 4 illustrates the projection zones of the solar image;

FIG. 5 represents a detailed view of the setup of the secondary mirror (9) equipment (9);

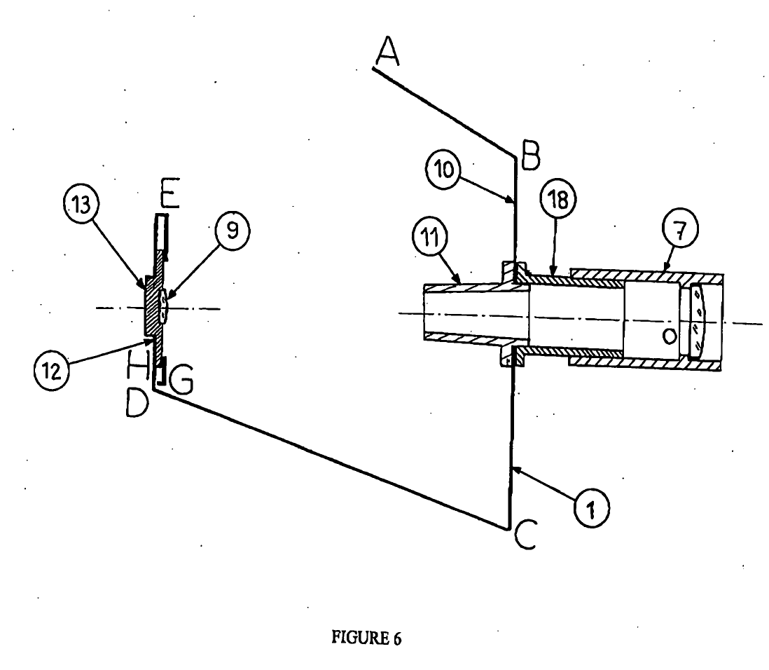

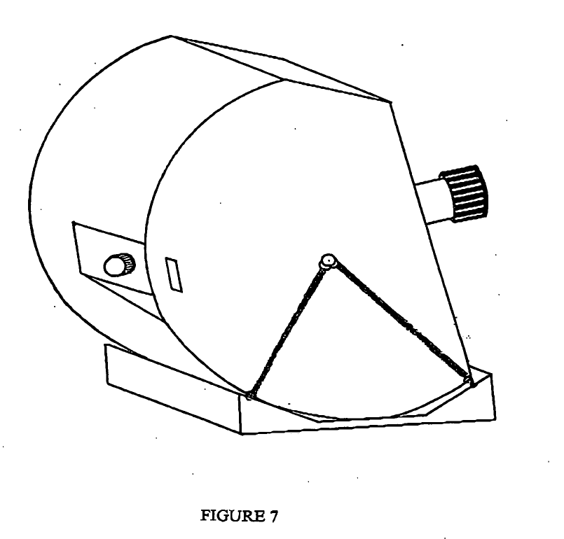

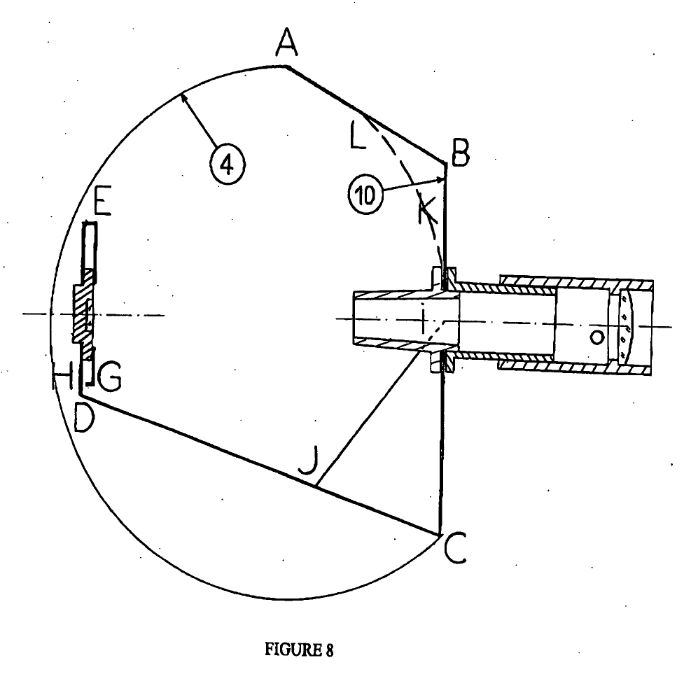

FIG. 6 represents the means employed to make the continuous cardboard structure rigid along ABCDEGH: AB forms a sun screen, BC is the projection screen (10) of the image on the internal surface and sun screen (1). It receives the lens-carrier tube (7, 11 and 18). CD forms a reinforcement board, DE (12) supports the secondary mirror equipment (9), EG provides for the rigidity of the secondary mirror and allows the light to pass into its central part, GH provides for attachment by means of a reversible procedure;

FIG. 7 represents an external appearance of the system seen from the observer side;

FIG. 8 represents a lateral view of the telescope case and positions of additional screens for the comfort of observation;

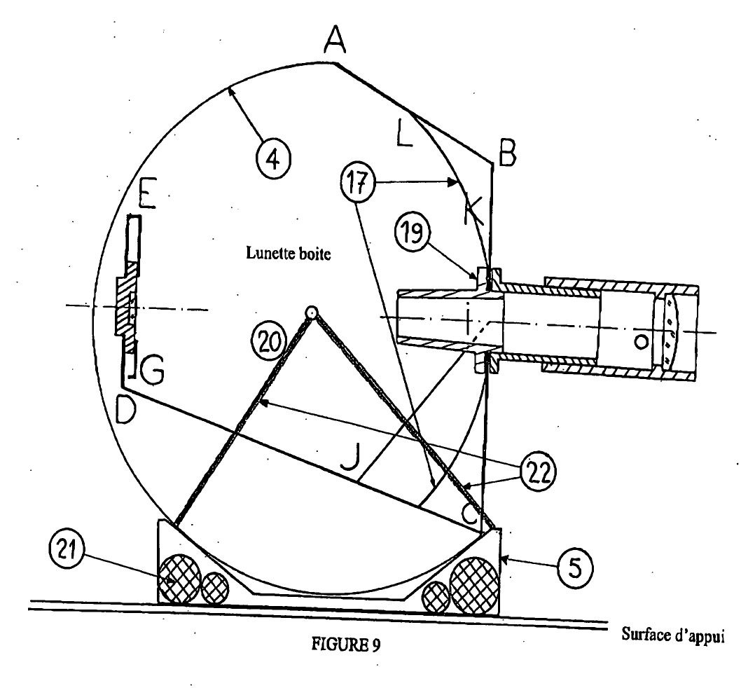

FIG. 9 represents a sectional view of the assembly on its support base, with representation of the ballast (21) of the support tension elements (22) and the option spherical projection screen (17) and its support washer (19);

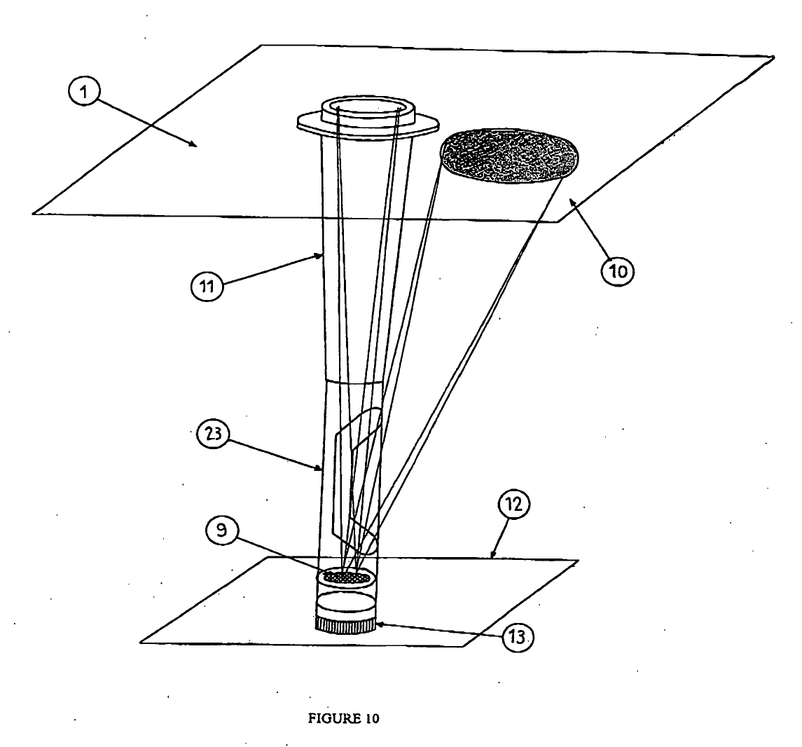

FIG. 10 represents a cut-out for the passage of light in the case in which the objective and the secondary mirror are linked directly;

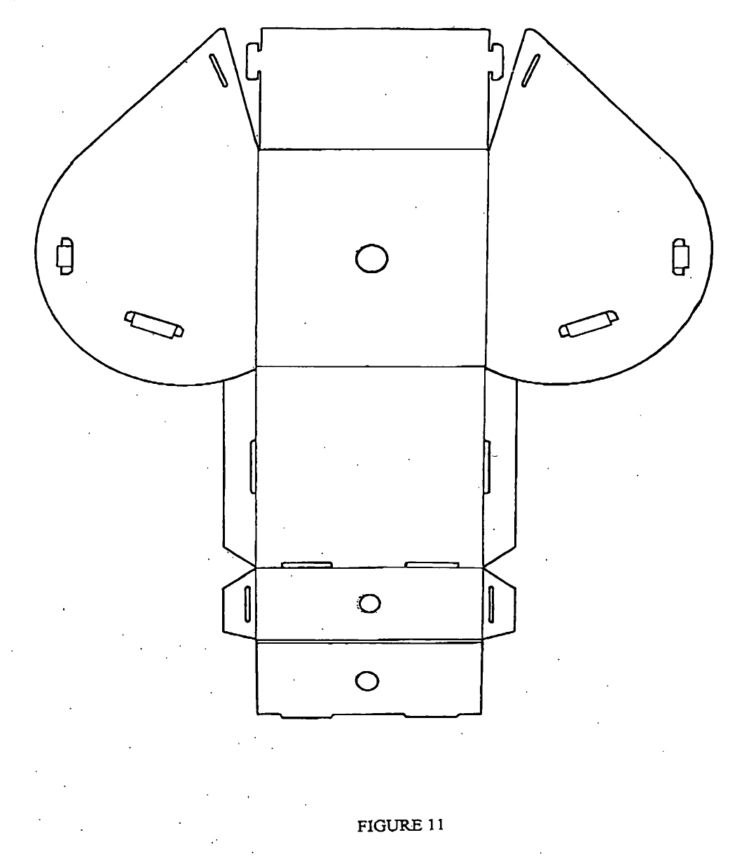

FIG. 11 represents a cut-out (bold lines) and folding (fine lines) of the cardboard sheet which will form the “telescope-case”;

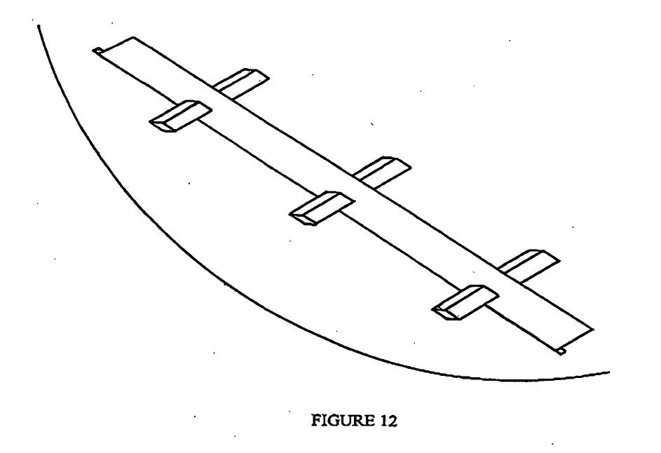

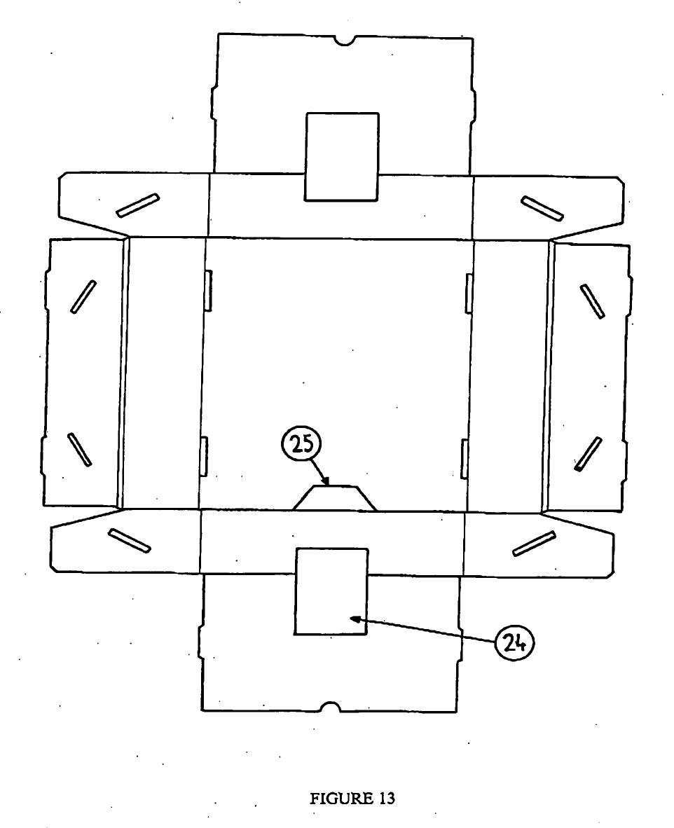

FIG. 12 represents a detail of a possible method of assembly;

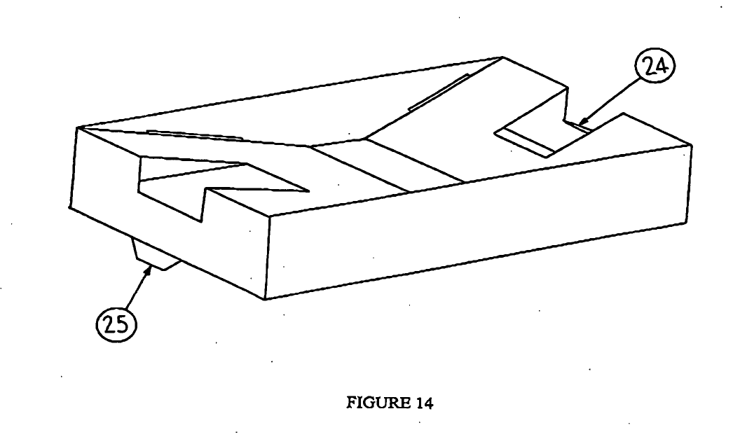

FIG. 13 represents a cut-out (bold lines) and folding (fine lines) of the cardboard sheet which will form the support. The cut-outs (24) allow the loading of the possible ballast which will stabilize the base and the cut-out (25) will form the stabilizing foot;

FIG. 14 is an implementation of the base from the sheet of FIG. 13.

Compared to the other existing systems, the arrangement (FIG. 1) of the projection screen which also serves as a screen (1) for protection from direct solar radiation ensures an increased viewing comfort because the observer thereby is shielded from the brightness of the ambient solar light. A protective flap (2) improves this comfort.

Finally, the site implementation does not require any delicate adjustment because the instrument does not need more than a more-or-less flat support surface (3) such as a table top, the roof of a car or a fairly smooth solid surface. Azimuth orientation is implemented by turning the system assembly on this support surface. Height adjustment is performed by means of the circular form of the flanges (4) that close the case enclosing the optical system and which slide on the inclined planes enclosed in a base (5). The view is obtained by means of the shadow (6) of the objective carrier tube (7 and 18) on the surface of the screen turned toward the sun. The finest view is obtained directly by focusing the solar image in the diffusing screen. The perfection of the image is obtained by adjusting the incline of the objective, the secondary mirror being henceforth fixed in the structure.

An objective (8) (FIG. 2) of diameter D comprised between 2 and 5 cm and of focal length F comprised between 30 and 50 cm forms an image of the sun near the focus of a secondary mirror (9), which can be concave or convex (it is shown as convex in FIG. 2). This mirror projects an enlarged image of the sun onto a screen (10), the other surface of which (1), turned toward the sun, ensures a sufficient luminous protection such that the image formed on the projection surface can easily be perceived by the naked eye. For this purpose, the diameter of the solar image will be selected to be between two and three time larger than the diameter of the objective.

The objective (8) will be achromatic either by the classic use of two mineral lenses or of two organic lenses if the optics are molded, either achromatized by addition of a network of Fresnel regions on one surface if the goal is to create a single piece of molded organic glass.

The objective (8) is fixed in a tube formed of three sections of variable length (external part (7) and (18), internal part (11)), which surround the screen (1) when they are assembled such that they form with the support plane (12), of width c+c′, of the secondary mirror (9) an inexorable obstacle to a direct ocular observation of the solar radiation (FIG. 3). The secondary mirror (9) and its support (12) of width c+c′ will be inseparable by construction such that the eye cannot have access to the solar image in the focus of the objective by removing the mirror (8). The distance of the secondary mirror (9) from the objective (8) can be adjusted by screwing up or down of the cylinder (7) on the objective carrier tube.

The projected solar image can be centered on the path of the axis of the objective carrier tube (FIG. 4a), which gives the most satisfying quality but eliminates the center of the solar disk. Since, in any case, the diurnal movement moves away the image of this ideal centering in several minutes, there is nothing to prevent observation of a nonaxial image, not blocked by the objective (FIG. 4b). The optical calculations verified by experiments show that the fineness of the perceptible details remains excellent.

The screen (1) and the support (12) of the secondary mirror (9) form the two surfaces of an almost entirely closed space which will be materialized by a cardboard structure forming a rigid, orientable case (FIGS. 1 and 7). This structure can be unfolded from a pre-cut flat cardboard which is prefolded such that the user only has to set it up in order to maintain its shape.

The secondary mirror (9) is fixed in a fixed cylinder inserted in the cardboard sheet 12 which forms the back of the device. It is not adjustable. This sheet itself is a part of a cardboard flap ABCDEGH (FIG. 6) extending the screen BC (1) and folded so as to ensure the rigidity of the general structure and the support sheet of the secondary mirror.

The lateral surface ABCDEGH is inserted between two flanges (4) with partially cylindrical contours which function as support elements (FIGS. 1, 7 and 8).

Observation of the solar image is performed by watching the projection screen (10) through the opening AE (FIG. 8). When the sun is low, the image will be formed on the top part of the screen BC (side B) and when the sun is high, preference will be given to projection on the bottom part (side C). But the comfort of observation can be improved by adding in the bottom part a complementary light screen IJ better positioned in relation to the position of the observer. The quality of the images will be improved by curving inward this light screen so as to make it cylindrical along an axis parallel to IJ passing close to the focus of the objective. The projected image in the top part of the screen will also be improved by added an incurved screen IKL close to the cylinder of normal axis in the figure plane and passing through the focus of the objective O.

For a more sophisticated model, it is possible to provide (FIG. 8) a spherical projection screen (18) made of a white diffusing plastic material, the center of which would be close to the focus of the objective and the radius equal to F−a. It would then double the posterior surface of the sun-screened screen (1). It is thereby possible to improve the quality of the images most remote from the center while also improving the comfort of observation.

In the attached figures, the sheet “ED” is a sheet of width c+c′.

In a more sophisticated option, it is possible to combine in a single unit (FIG. 10) the tube (11) and the secondary mirror (9) the remote adjustment of which will then be performed in the construction which will avoid the adjustment fumblings of users who are not accustomed to optical adjustments. This connection (23) is provided by extending the part (11) to the length b=F−a and by providing one or more lateral cut-outs to allow passage of the light to the projection screen. The solid unit thus formed by the objective (8), the objective carrier tube (7), the tubes (11 and 17) and the secondary mirror (9) can rotate in a circular opening penetrating the center of the screen (1) so as to be able to orientate the cut-out of the tube (11) toward the zone of the screen (10) where it is desired to form the solar image. The posterior part of this tube (11) which is also extended is supported by being engaged in a circular hole of the sheet (12). The knurled end allows orientation by rotation of the cut-out.

The case which contains the unit, which is folded for shipment and storage, can be transformed into a support (5) on which slides the circular part of the preceding assembly, referred to from hereon as “telescope case” (20) according to the diagram shown in FIG. 9.

Care must be taken that the circular flanges (4) cannot be engaged between the inclined planes and the lateral surfaces of the support base (5). Tabs engaged along these surfaces can prevent this problem (FIG. 14).

On the base (5) is provided a support key (FIGS. 12 and 14) which promotes the orientation of the view of the device when the sun is high on the horizon. Also provided is the place (21) for the introduction of rollers or other stabilizing ballasts for the case in which the intensity of the wind is too strong. In this case (FIGS. 1, 7 and 9), elastic tension elements (22) join the center of the circular flanges at carefully chosen points of the support base.

The internal surfaces of the flanges are painted black or dark blue or other dark color so as to provide optimal contrast of the solar image by attenuating the diffused radiation. The same is true of the internal surface of AB and CD or CG. The surface EG is diffusing and of metallic color so as to prevent it from being heated by the solar radiation stemming from the primary image when it is poorly centered, i.e., during plotting and especially when the instrument is left standing after a viewing of the sun.

The lateral flanges are spaced further apart than c+c′ such that the direct solar image cannot form on them and thus risk their carbonization. With the same safety intention, the interior of the tubes (7), (11) and (18) and optionally (23) are treated so as to be reflective or at least white in color. However, tests performed with an objective with a useful diameter of 38 mm and a focal length of 450 mm showed that the heating effect was weak and had no impact because of the diurnal rotation such that the images of the sun do not remain for very long on a point and therefore cannot cause dangerous heating effects. This comment also applies to the heating of the secondary mirror (9) which absorbs four to five times more solar power than a black body exposed directly to the sun; but this does not lead to a heating effect greater than 10 or 20° C. for a solar passage of one or two minutes.

The base (5) of the system should be placed on a fairly regular, preferably flat surface on which the azimuth orientation can be performed. The height orientation is obtained by turning the telescope case (20) on its circular part in the support base (5). The direct image of the sun will appear somewhere on the surface EG. Centering on the secondary mirror will then be easily performed as will final centering on the desired screen portion. The gross acquisition of the solar image is obtained by observing the shadow on the objective carrier tube (7) and (18) and brought onto the protector screen (1). The fine focusing of the image is done by sliding this objective carrier tube (8) either by rotational movement in the case of threaded adjustment or by translational movement for sliding adjustment until obtaining a satisfactory image. If one uses the preadjusted version, this latter operation is not required; all that needs to be done is to orient the cut-out of the tube towards the part of the screen where it is desired to form the solar image.

The telescope case structure and its base can be made from a sheet of cardboard which has been strongly cut in advance and folded, delivered in a mode involving inserting the folded structure—which will later be unfolded to create the telescope case—inside the base the shipping and storage package. FIGS. 11, 12, 13 and 14 illustrate this possibility without excluding other cutting and folding solutions for obtaining the same result. The same is true of the assembly system based on pegs represented in FIG. 13 which can be replaced by other methods such as those using Velcro, pressure buttons, two-tailed rivets with washers, etc. Preference is given to reversible methods which allow easy disassembly for easy transport and storage, and provide for the most rigid and reproducible relative positioning of the elements. In the examples of implementation described above, the distance of the secondary mirror (9) from the objective (8) is adjusted in relation to the cylinder (7) solely on the objective carrier tube. Thus adjustment can be implemented by screwing in a threaded cylinder or by displacement in a sleeve implementing a dry braking of the tube in which are placed the lenses forming the objective.

A variant of implementation consists of providing an additional adjustment by displacement of the mirror along an axis perpendicular to the plane of the mirror. This adjustment can be implemented by a threaded base allowing longitudinal displacement of the mirror along the optical axis. The mirror is then supported by a threaded rod which cooperates with a connector piece with the case and presents a threaded orifice for the screwing movement of the threaded rod. The objective is fixed in a cylinder sliding in a sleeve for obtaining an initial focusing of the image.

Adjustment of the focusing would then be performed by positioning of the objective (8) in relation to the sleeve. The tube comprising the objective would be displaced until the initial rough focusing is obtained. Final focusing would then be performed by screwing or unscrewing of the mirror (9).

1. Device for observation of the back-projected image of the sun on a screen (10), characterized in that said screen also provides protection from the ambient light.

2. Observation device according to claim 1, characterized in that it comprises an achromatic objective (8) and a concave or convex secondary mirror (9) which back-projects the enlarged image of the sun onto the posterior surface of the sun-screened screen (10).

3. Observation device according to claim 1 or 2, characterized in that the objective is fixed in a threaded cylinder which allows focusing of the image.

4. Observation device according to claim 1 or 2, characterized in that the objective is fixed in a cylinder that slides in a sleeve for the focusing of the image.

5. Observation device according to claim 3 or 4, characterized in that it also comprises a means for the displacement of the mirror (9) along the optical axis.

6. Observation device according to claim 5, characterized in that it comprises a first focusing adjustment means constituted by a sleeve cooperating with a cylinder supporting the objective (8) and a second focusing adjustment means constituted by a threaded base integral with the mirror (9).

7. Observation device according to claim 1, characterized in that the support structure of the optical parts forms a flexible rigid assembly that can be oriented in height toward the sun by means of a base (5) at inclined planes on which slide circular lateral flanges (4).

8. Observation device according to claim 7, characterized in that the centers of the flanges (4) are connected to the base by elastic tension elements (22).
